(19) United States
(12) Patent Application Publication
(10) Pub. No.: US 2024/0273113 A1
(43) Pub. Date: Aug. 15, 2024

(54) METHOD OF IMPORTING DATA TO DATABASE, ELECTRONIC DEVICE, AND STORAGE MEDIUM

(71) Applicant: Beijing Baidu Netcom Science Technology Co., Ltd., Beijing (CN)

(72) Inventors: Ming ZHANG, Beijing (CN); Yanyan LI, Beijing (CN); Lili LI, Beijing (CN); Jingbo ZHOU, Beijing (CN)

(21) Appl. No.: 18/642,571

(22) Filed: Apr. 22, 2024

(30) Foreign Application Priority Data
Apr. 23, 2023 (CN) 202310445488.8

(51) Int. Cl. G06F 16/25

(52) U.S. Cl. CPC G06F 16/258

(57) ABSTRACT

The present application relates to a field of big data technology, in particular to a field of data storage technology. More specifically, the present disclosure relates to a method of importing data to a database, an electronic device, and a storage medium. A specific implementation solution is: acquiring incoming data from a data source according to a database config file; the incoming data is original data directly acquired from the data source; calculating and processing the incoming data according to the database config file to obtain computational data; the computational data is obtained by integrating and calculating the incoming data; writing the incoming data and the computational data into a database.

### CROSS-REFERENCE TO RELATED APPLICATION(S)

This application claims the benefit of Chinese Patent Application No. 202310445488.8 filed on Apr. 23, 2023, the whole disclosure of which is incorporated herein by reference.

### TECHNICAL FIELD

The present disclosure relates to a field of big data technology, in particular to a field of data storage technology. More specifically, the present disclosure relates to a method of importing data to a database, an electronic device, and a storage medium.

### BACKGROUND

In a field of business intelligence (BI), data is always the most important part. Among all BI tools, how to acquire and process data is the most crucial step, as the quality of data directly affects the final output of the product. In the BI product of transportation big data report, it is needed to output an intelligent interpretation report by using indicator data in the database combined with a report template configured by a user and the selection of time and space.

Due to the need for complete data for the big data report, it is needed to traverse and access a database interface, returning one data per access. In addition, it is also needed to integrate and calculate the data acquired from the database, which is very complex. The method of acquiring data is very inefficient, and the form of data acquired is also very single, which cannot meet the diverse data acquisition needs of the user.

### SUMMARY

The present disclosure provides a method of importing data to a database, an electronic device, a storage medium, and an intelligent transportation data system.

According to an aspect of the present disclosure, a method of importing data to a database is provided, including:
acquiring incoming data from a data source according to a database config file; wherein the incoming data is original data directly acquired from the data source;
calculating and processing the incoming data according to the database config file to obtain computational data; wherein the computational data is obtained by integrating and calculating the incoming data; and
writing the incoming data and the computational data into the database.

According to another aspect of the present disclosure, an electronic device is provided, including:
at least one processor; and
a memory communicatively connected to the at least one processor, wherein the memory stores instructions executable by the at least one processor, and the instructions, when executed by the at least one processor, cause the at least one processor to implement the method in any one of the above technical solutions.

According to another aspect of the present disclosure, a non-transitory computer-readable storage medium having computer instructions stored thereon is provided, wherein the computer instructions are used to cause a computer to implement the method in any one of the above technical solutions.

According to another aspect of the present disclosure, an intelligent transportation data system is provided, including the electronic device in the above technical solutions.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, in which:

FIG. 1 is a schematic diagram of a structure of a system of importing data to a database in the existing technologies;

FIG. 2 is a schematic diagram of steps of a method of importing data to a database in an embodiment of the present disclosure;

FIG. 3 is a schematic diagram of a structure of a system of importing data to a database in an embodiment of the present disclosure;

FIG. 4 is a display interface diagram of an updated indicator displayed on a product side in an embodiment of the present disclosure;

FIG. 5 is a block diagram of a principle of an apparatus of importing data to a database in an embodiment of the present disclosure;

FIG. 6 is a block diagram of a principle of a data-importing-to-database module in an embodiment of the present disclosure;

FIG. 7 is a block diagram of an electronic device used to implement a method of importing data to a database in an embodiment of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

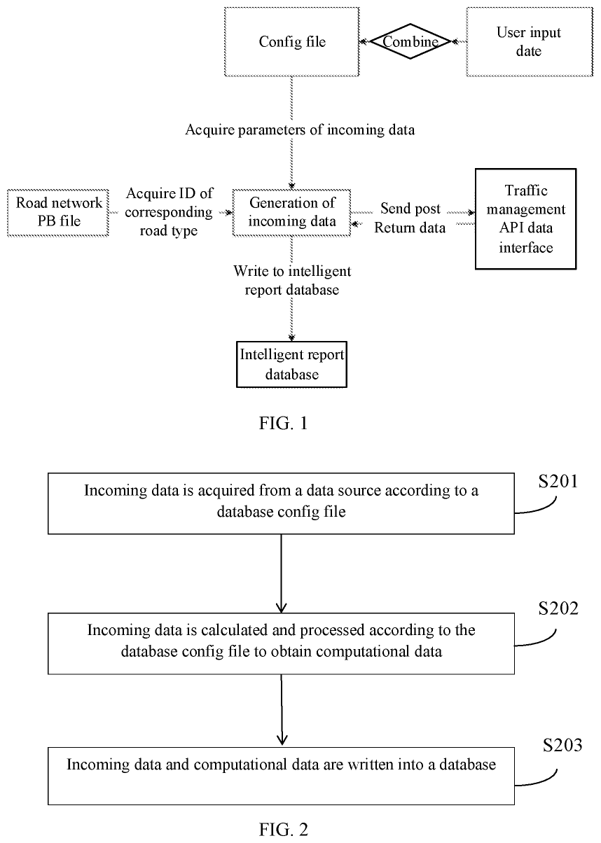

As shown in FIG. 1, the existing data system mainly acquires data and imports the data to a database according to a road network file, a config file, and a date input by a user. The method of acquiring data is very inefficient, and the data type is single, which cannot meet the diverse needs of data acquisition. For example, in FIG. 1, when importing the data to the database, original data may only be requested from a data source (an upstream database) through a data interface, and the original data is simply processed to generate incoming data. The incoming data refers to the more intuitive data in the original data, such as a traffic flow and a speed at a certain intersection at a certain time, but cannot provide composite data, such as a congestion index at a certain intersection at a certain time, for generating an intelligent analysis report. The congestion index needs to rely on further calculation and integration on the incoming data. For example, the congestion index is obtained by comprehensive calculation according to indicators such as the traffic flow and the speed at the intersection. In a case that the existing data system only provides the incoming data, the user needs to calculate and integrate the incoming data to generate the intelligent report after the user acquires the incoming data. The efficiency of acquiring data is too low for the user.

The existing road network file provides information about a road network of a city, such as intersections in the city and the ID (Identity document) of each intersection. The ID here is consistent with the ID used when accessing the data interface, so when it is desired to acquire the indicator data of all intersections, the IDs corresponding to all intersections in the road network file are loaded first, and then the corresponding data is retrieved from the upstream database according to the ID of the intersection. For example, assuming that an ID corresponding to an intersection is “R0001” and now it is needed to retrieve the traffic flow at the intersection at 10:00 a.m., the system may retrieve the corresponding traffic flow from the upstream database according to the ID “R0001”.

The config file of the existing data system mainly determines which indicator data needs to be generated. Such config file may be manually configured in advance. Each row in the config file represents one indicator, and the config file also provides certain specifications on how to pump data for each indicator, such as determining the name, access address, and time granularity (fifteen-minute level or hour level) of the indicator. However, currently the request parameters for the config file are fixed, which cannot handle diverse data requests.

The existing data system may only rely on a fixed date input by the user when acquiring data, without providing any routine tasks. For example, if the user input a date such as Mar. 1, 2023, the existing data system may only acquire data for Mar. 1, 2023. When the system is specified to acquire data for a specified date (which may be data of a day or aggregated data of a month), the system may traverse all indicators in the config file to acquire the data. The data system may first classify all indicators by a road type (intersection, road, etc.). After completing the indicator data for one road type, the system may update such indicator data to the database of the big data reporting system.

The biggest problem with the existing data system is the poor scalability of the config file. Because the data form of the original data source is very single, only a fixed form of ID, frequency, and start and end time need to be sent when acquiring data at each interface, and the request form is fixed. However, with the growth of business demand, more and more forms of data are emerging, so that the fixed form may no longer meet the diverse needs of data acquisition when sending data requests. For example, the previous time format for acquiring data is “2022-03-26 8:00:00”, but after data expansion, the data format may be “20220326” or only monthly time. In addition, the previous data source interface has a one-to-one correspondence with the indicator, but after business growth, there may be a one-to-many and many-to-one correspondence between the data source interface and the indicators of the reporting system. However, the current config file design is completely unable to meet such requirement.

The insufficient scalability of the existing data system is also reflected in the single form of data acquisition. As business requirements increase, it is needed to not only acquire data from a traffic management data source, but also integrate, calculate, and rank the existing data in the database. For example, it is needed to know the top 10 most congested intersections on a date in an area, as well as their corresponding congestion indexes and average vehicle speeds, or it is needed to know the most congested periods in an area, as well as their corresponding congestion indexes and average vehicle delays. The current config file may only guide to acquire data but cannot further calculate according to the existing data.

The efficiencies of data acquisition, data importing to the database, and presentation on the product side in the existing data system also have problems. When acquiring daily data of the road network of the city, it is needed to traverse several road types and access thousands of units using different indicators. Millions of accesses require almost a day to complete tasks currently, and the instability of on-site interfaces often causes unnecessary burden on the data system. The existing data in the database is not checked when importing data to the database. It is not necessary to reacquire the existing and complete data. When presenting the data to the product side, it is needed to manually add the indicator. Therefore, when the number of indicators is particularly large, updating the indicators becomes extremely cumbersome.

For the above-mentioned technical problems in the prior art, the present disclosure provides a method of importing data to a database, as shown in FIG. 2, including operations S201 to S203.

In operation S201, incoming data is acquired from a data source according to a database config file; wherein the incoming data is original data directly acquired from the data source.

For example, the original data may include user data (data collected under user authorization) acquired from the data source, such as traffic data provided by a map application, which may be generated based on a mobile terminal and may include but not limited to real-time location information, driving speed information of users. The original data may also include public transportation data, such as data in a public transportation card terminal system, the number of people taking public transportation, boarding and alighting vehicle data, and the number of people entering and exiting stations, as well as the boarding situation of key routes, key stations, and key periods may be analyzed at any time by analyzing traffic card data and GPS data of public transportation vehicles. The original data may also include data in a video surveillance system, including road monitoring devices installed by the traffic management department, as well as monitoring networks installed by emergency, education, and urban managements, especially high-definition video cameras, which may accurately record detailed vehicle information such as vehicle types, license plates, and speeds, and pedestrian passing information may be acquired quickly and accurately by using multifunctional electric alarm devices and pedestrian crossing red light capture devices installed at some intersections combined with facial recognition technology. The original data may also include urban vehicle GPS data, such as the location information data of transportation vehicles such as taxis and ride hailing services, which may also expand road condition data. Various road sections and various types of vehicles may also be monitored in real time by connecting with the network of the management department, so as to provide supplementary data.

The database config file is pre-configured manually, including a plurality of target parameters, such as the road type, the indicator name, the data type, etc. as shown in Table 1. The target parameters are not limited to the parameters listed in Table 1. Other parameters may be added according to real application scenarios. The database config file is used to guide the system to preprocess the original data before importing the data to the database, and determine which indicator data needs to be generated and how to generate the indicator data according to one or more target parameters. As shown in Table 1, each row in the config file represents one indicator. The config file also provides certain specifications on how to pump data for each indicator, such as determining the name, access address, and time granularity (fifteen-minute level or hour level) of the indicator.

TABLE 1
Target parameters contained in the database config file

| Parameter | |
|---|---|
| name | Description |
| Road type | The road type presented by the corresponding indicator, |
| | such as intersections, roads, etc. |
| Indicator name | Indicator name when displayed on a user side |
| Data type | Incoming data or computational data |
| Indicator | Some special indicators may only appear in monthly or |
| acquisition | daily scenarios |
| granularity | |
| Scope request | One or more parameters required to access daily data |
| parameter | |
| Aggregation | One or more parameters required to access weekly and |
| request | monthly data |
| parameter | |
| Data format | The specific format of data: one-dimensional, |
| | two-dimensional, three-dimensional |
| Scope request | The address required to access daily data, which may be |
| address | more than one |
| Aggregation | The address required to access weekly and monthly data, |
| request address | which may be more than one |
| Time | The selected data frequency, such as fifteen-minute level |
| granularity | or hour level, etc. |
| Selected index | The index selected to display in the data, such as |
| | congestion index, congestion mileage, etc., and multiple |
| | options are available for three-dimensional data |
| Selected time | The time period selected to display in the data, such as |
| period | morning rush hour, evening rush hour, etc., and multiple |
| | options are available for three-dimensional data |

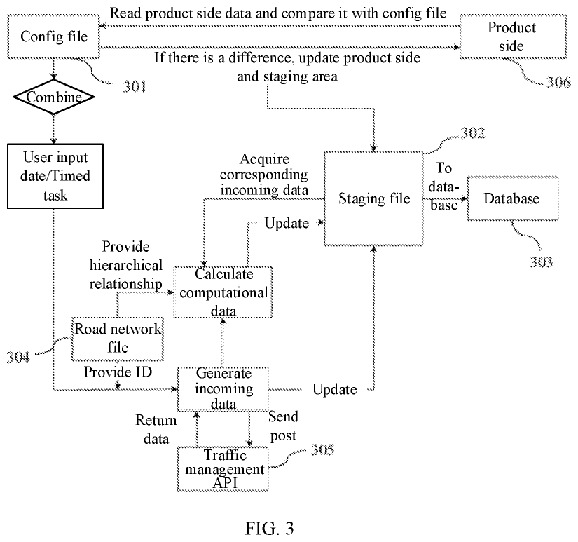

As shown in FIG. 3, the incoming data refers to the data that needs to be acquired through accessing the data source interface. In the embodiment, the data source interface may be a traffic management API (Application Programming Interface) 305. The incoming data may be original data directly acquired from the data source (such as the upstream database) through the traffic management API 305, such as real-time location information of users, driving speed on a certain road, etc.

In operation S202, the incoming data is calculated and processed according to the database config file 301 (the config file shown in FIG. 3) to obtain computational data; wherein the computational data is obtained by integrating and calculating the incoming data, and cannot be directly acquired from the data source.

As shown in Table 1 and FIG. 3, in order to adapt to a wider range of data acquisition needs, data is divided into the incoming data and the computational data in the present disclosure. The computational data requires further integration and calculation of the already acquired incoming data. For example, road traffic congestion (computational data) is calculated according to real-time location information of users and driving speed information (incoming data). The traffic management department may obtain a large amount of real-time basic user data through docking, and the system integrates and calculates the massive incoming data to obtain the computational data.

In operation S203, the incoming data and the computational data are written into a database.

The incoming data and the computational data are imported to the database, so that the data types in the database become more diverse. When users need, the incoming data and/or the computational data may be directly acquired from the database and quickly feed-backed to the user through the APP. The accuracy, real-time performance, and reliability of the data are high, and the cost and difficulty of acquiring the data are low. The generated computational data may also be directly applied to generate the intelligent analysis report required by the user. In this way, the user does not need to further integrate and calculate the computational data after acquiring the required computational data, significantly improving the efficiency of data acquisition and the user experience.

As an optional implementation, as shown in FIG. 3, in operation S203, writing the incoming data and the computational data into the database includes:
writing the incoming data and the computational data into a staging file 302;
checking whether a data format of the incoming data and a data format of the computational data in the staging file 302 is consistent with a preset data format in the database config file;
writing, in response to the data format of the incoming data and the data format of the computational data being consistent with the preset data format, the incoming data and the computational data from the staging file 302 into the database 303; and
modifying, in response to the data format of the incoming data and the data format of the computational data being inconsistent with the preset data format, the data format of the incoming data and the data format of the computational data to be consistent with the preset data format, and writing the modified incoming data and the modified computational data from the staging file into the database.

As shown in FIG. 3, the system of importing data to the database in the embodiment introduces a staging area as an intermediate layer between data acquisition and data importing to the database. The staging area may store data in a form of CSV (Comma-Separated Values) locally. The data may be imported to the database through query writing on these CSV files. In addition to the form of CSV, the data may also be in other forms. The introduction of the staging area is mainly to reduce the number of interactions between the data system and the database, as too many direct read and write operations on the database are unsafe. When it is uncertain whether the data in the data source is complete, writing the data directly to the database may affect the security of the database. For example, the existing data task requires 10 write operations on the data. However, when an error occurs or a data quality issue is discovered during the 5th write to the database, it is needed to not only locate the problem of the data source, but also delete the erroneous data that has already been imported to the database, which is an unsafe operation for the database. Therefore, in the embodiment, the data accessed each time is first written to the staging file in the form of CSV. When the data task is completed, all data in the staging file is updated to the database after confirming that data formats of all data are correct. In this way, for a data read task, the system may only have one update and write operation on the database, improving the security of read and write operations on the database.

For example, the format check program may automatically check the data format before importing the data in the staging file to the database, so as to confirm if there are any errors in the data format. Whether the data format of all data in the staging file is consistent with the preset data format in the database config file is checked. Whether each column of the incoming and the computational data in the CSV format is consistent with the database config file is checked. For example, according to the database config file in Table 1, if the first column of data is “road type”, whether the first column of data in the staging file is also “road type” is checked, and whether there are any empty values in each column is checked. It is determined whether the data format of all data in the staging file meets the requirements of the database config file, that is, whether the data format of all data in the staging file is consistent with the preset data format. If it is determined that the data is correct, the data in the staging area is written to the database as a whole. If some data formats in the staging file are found to be incorrect, the data formats are modified until all data formats meet the requirements of the database config file before being imported to the database, so as to ensure the security of the database.

As an optional implementation, in operation S203, writing the incoming data and the computational data into the database includes: processing the incoming data and the computational data into a plurality of data slices; and writing the plurality of data slices in batches from the staging file into the database.

As mentioned above, the existing data system sends a large number of data requests to the data source when acquiring data, which requires a lot of time. The data system in the embodiment provides a multi-threaded mode when accessing the interface, greatly reducing the access time. During the stage of importing data in the staging area to the database, data slicing is also used to accelerate the data importing process. When the CSV data has thousands of rows, writing through an insertion statement, or writing with an insertion statement for each row, may be very time-consuming. Therefore, when importing the data to the database, the data in the large CSV file may be imported to the database in batches, with 500 pieces of data imported to the database in each batch. Such method of importing data to the database in batches may save a lot of time for importing data to the database.

As an optional implementation, acquiring incoming data from a data source according to a database config file includes the following operations.

A data runtime period is acquired. The data runtime period includes a user input date or a preset date. The user input date refers to a date input by the user in real-time, indicating which time period of data the user wants to acquire, such as data of Mar. 1, 2023. The preset date may be pre-set in the data system, for example, data of the previous day may be run at 1 a.m. every day.

According to the database config file, the original data corresponding to the data runtime period is acquired from the data source as the incoming data.

For example, the data runtime period may be a date actively input by the user or a preset date, that is, running data tasks at a predetermined time may be supported. In order to make data tasks more convenient to run during product deployment, two new functions are added for the data system, including one-click initialization startup and timed tasks. When users run the data system of the present disclosure, they may also not input the date, and the system may automatically run the daily data of recent 14 days, weekly data of recent two weeks, and monthly data of recent two months to assist in generating daily, weekly, and monthly reports for traffic management scenarios. The data system may also be preset to perform a timed run on the data of the previous day, week, or month at 1:00 am every day, on every Monday, or on the 1st of every month. In this way, users do not need to manually input any dates, and the data system may automatically acquire the data for all dates required by the user, improving the convenience for the user to acquire data.

As an optional implementation, acquiring incoming data from a data source according to a database config file further includes:
acquiring a first target parameter corresponding to the incoming data from the database config file 301, as shown in FIG. 3;
acquiring an identity document corresponding to each road in the incoming data from a road network file 304; wherein the incoming data is traffic data, and the road network file includes the identity document corresponding to each road in the traffic data and a hierarchical relationship between roads; and
acquiring, according to the identity document and the first target parameter, the corresponding original data from the data source as the incoming data.

As shown in Table 1, when the types of data sources and the required indicator data increase, the request parameters for many data may also differ, and certain data is needed to provide data with specific granularity, such as certain indicators only having monthly data. In order to better cope with these complex scenarios, indicators such as the data type, the indicator acquisition granularity, and the request parameter are added. The data type determines whether the indicator is the incoming data or the computational data. The indicator acquisition granularity may help avoid invalid access. If an interface only has monthly data, then the interface may not be accessed when running a daily data task. The request parameter specifies a necessary header to access an interface, and each header corresponds to a respective return data format.

The request parameters and addresses in Table 1 are divided into scope requests and aggregation requests. Here, the scope request parameter and the scope request address help to acquire daily data, such as the congestion index of an intersection every 15 minutes within 24 hours. The aggregation request parameter and the aggregation request address help to acquire aggregation data (weekly, monthly) in a plurality of days, such as the congestion index of a specific intersection every 15 minutes within 24 hours of a certain month in a year. The data of one indicator may be for a day or a month, but the interface address and the request parameter for the days are different from those for the months, so two separate fields are used to distinguish them. When the system runs a data task for a specific date or month, the corresponding scope or aggregation interface may be selected according to the database config file for data acquisition. Through the above technical solution, richer incoming data is generated according to the target parameters provided in the database config file and the IDs provided in the road network file.

The road network file is a PB file, where P refers to the protocol and B refers to the buffer. The road network file is a map of a city that provides road network information of the city, such as the intersections in the city and the ID of each intersection. The ID used here is consistent with the ID used when accessing the data interface, so when it is desired to acquire the indicator data of all intersections, the system may load all IDs in the road network file first. In the embodiment, the road network file not only provides all IDs for different road types, but also provides hierarchical relationships for different road types. For example, a region may have sub-regions, and each sub-region may have different roads, with different road sections and intersections for each road. Based on the IDs and hierarchical relationships provided by the road network file, richer indicator data may be obtained when generating the computational data.

As an optional implementation, data formats of the existing data system are only one-dimensional or two-dimensional, while the data system in the embodiment adapts to the newly added three-dimensional data. One-dimensional data refers to a single numerical value or text, typically appearing in the form of an integer, float, or text in the database. Multi-dimensional data is generally in a jsonb format in the database. Different types of jsonb data have different partitioning rules, such as KV (source code files written in Kivy language), SIV, and the like. All jsonb data may be stored in a form of double list in the database. Dimensions of the jsonb data correspond to the length of each inner list. The length of a name of each jsonb data corresponds to its dimension, where each character in the name represents a different meaning. 2D jsonb data is generally in the form of KV, with each internal array containing a key value pair. The format of the 2D jsonb data is, for example, [[“7:30-9:00”, 1.354], [“17:20-19:05”, 1.345] . . . ].

Due to the increasing complexity of data in traffic management scenarios, two-dimensional data storage formats may no longer meet the needs of user in data acquisition. For example, when the data source provides frequent congestion periods for a certain month and data for different indicators during these periods, the user may need data in a third dimension. The newly added 3D jsonb format may be extended on the basis of 2D, as shown in Table 2. In the embodiment, three new characters are added, including space (S), time (T), and index (I). For example, the TIV format indicates that in each array, the first value represents the time period, the second value represents the index, and the third value represents the corresponding value.

TABLE 2
Description for characters in the three-dimensional data

| Character | Description |
|---|---|
| V | Value |
| K | Key |
| S | Space |
| T | Time |
| I | Index |

Table 3 presents the jsonb format data in the TIV format in a table form. By expanding the dimensions of the data, one-dimensional and two-dimensional data are extended to three-dimensional data, adapting to complex data. For different times, indexes, and spaces, further selection may be made in the database config file. For example, when acquiring jsonb data in the TIV format, the data source may return 5 indexes, but the user may only choose 3 indexes. In this situation, it is only needed to add the three indexes selected by the user in the field “selected index” (default to selecting all) of the config file.

TABLE 3
jsonb data in the TIV format

| | 07:30-09:00 | 17:30-19:05 |
|---|---|---|
| Average speed | 42.83 | 44.691 |
| Congestion | 90 | 105 |
| duration | | |
| Congestion index | 1.354 | 1.345 |
| Congestion | 28.884 | 24.024 |
| mileage | | |

As an optional implementation, in order to solve the technical problem that each indicator corresponds to one data interface in the config file of the existing data system, which is a one-to-one mapping relationship and cannot adapt to complex data, the data system in the embodiment extends to one-to-many mapping relationship and many-to-one mapping relationship of indicators and interfaces, adapting to more complex data.

For example, firstly, a plurality of data sources may provide data for an index in the database config file. As mentioned above, the scope data request and the aggregation data request are typical examples of the many-to-one mapping relationship, and such an index may have data such as daily data, weekly data, or monthly data. Another many-to-one mapping relationship is data with the same granularity provided by the plurality of data sources. For example, the data sources may have three types, including sub roads, parent roads, and trunk roads. However, the indicator in the present disclosure is specific to roads and includes these three road types. In order to enable the road indicator data to acquire data from these three data interfaces, three request addresses may all be written to the request address position of the database config file. In this way, the data system may traverse these data source interfaces to find suitable data for acquisition.

In addition, the data system also supports one data source to provide data for a plurality of different indicators. For example, a certain interface provides a congestion indicator for every 5 minutes in 24 hours of a certain day or of each day in a month, and such congestion indicator data includes indicator data such as a congestion index and a congestion mileage in the form of a dictionary. Assuming that indicator data of a five-minute level congestion index is to be established, the system may access this data source and use the field of selected index to select and list the indicator “congestion index”. Through the field of selected index, such data source may be used to establish indicators such as the congestion index and the congestion mileage, thereby achieving the many-to-one mapping relationship.

As an optional implementation, calculating and processing the incoming data according to the database config file to obtain computational data includes:
acquiring a second target parameter corresponding to the computational data from the database config file;
acquiring an identity document and a hierarchical relationship corresponding to each road in the computational data from the road network file; and
calculating and processing the incoming data according to the identity document, the hierarchical relationship, and the second target parameter, so as to obtain corresponding second indicator data as the computational data; wherein the calculating and processing includes at least one of: extracting the incoming data; integrating the incoming data; or ranking the incoming data.

For example, the establishment of computational data indicators is an important function of the data system in the present disclosure. The data system may not only access and adapt to the data interfaces provided by the traffic management, but also integrate, calculate, and rank the acquired incoming data. The system extracts, integrates, and ranks the acquired incoming data through fields of the config file such as the indicator name, the data type, the data format, the selected index, the selected time period, and the selected area. For example, if it is desired to know which intersections are most congested during a specific time period or morning and evening rush hour in a certain area on a certain day, 3D jsonb data in the STV form in the database config file may be selected, the need for the intersections with top five congestion index rankings are declared in the selected area, and the need for all day, morning rush hour or evening rush hour are declared in the selected time period. In this way, the data system may interpret the parameters in the database config file, so as to ultimately calculate the data required by the user as shown in Table 4.

TABLE 4
Examples of the computational data

| | | East | Intersection | | |
|---|---|---|---|---|---|
| | | intersection | of | | |
| | | of Kaitai | Shengxing | | Intersection |
| | Hongyang | Street and | Road and | | of |
| | and | Shunda | Lizhuang | Xinshichang | Longchang |
| | Dongguan | Road | Street | Street | Road |
| All day | 2.28 | 2.085 | 1.99 | 1.943 | 1.931 |
| Morning | 2.264 | 2.104 | 1.965 | 1.953 | 1.909 |
| rush | | | | | |
| hour | | | | | |
| Evening | 2.086 | 2.172 | 1.852 | 2.208 | 1.991 |
| rush | | | | | |
| hour | | | | | |

As an optional implementation, as shown in FIG. 3, the method of importing data to a database further includes:
reading product side data regularly;
determining whether a difference exists between the product side data and the database config file;
writing, in response to the difference existing between the product side data and the database config file, difference data into the staging file;
returning, in response to the difference not existing between the product side data and the database config file, to read the product side data regularly;
checking, after writing the difference data into the staging file, whether a data format of the difference data is consistent with the preset data format;
writing, in response to the data format of the difference data being consistent with the preset data format, the difference data from the staging file into the database; and
modifying, in response to the data format of the difference data being inconsistent with the preset data format, the data format of the difference data to be consistent with the preset data format, and writing the modified difference data from the staging file into the database.

Specifically, when certain new types of data need to be imported to the database, it may be needed to modify or reconfigure the database config file to adapt to the new type of data being imported to the database. If the data configuration on the product side is not modified, it may lead to a difference between the data configuration on the product side and the database config file. Therefore, the product side data may be regularly read to update the product side data as well as the data to be imported in the staging file in a timely manner, so as to ensure the consistency between the product side data and the database.

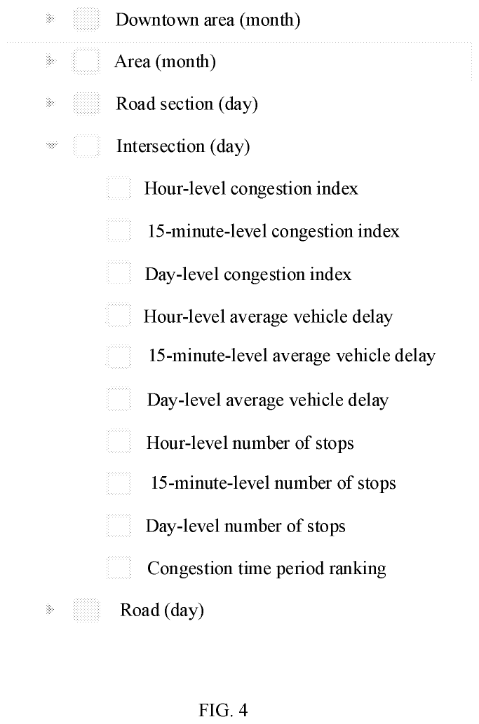

As an optional implementation, as shown in the architecture diagram of FIG. 3, the data system adds a module to display update indicators of the product side data. The existing data system completes the task once the data is imported to the database. However, if the update indicators are needed to be displayed on the product side, the existing data system needs to add these update indicators one by one at the product level. When the number of new indicators is large, this step may consume a lot of time. Therefore, the data system in the embodiment achieves automatic display of updated indicators on a product side 306, as shown in FIG. 4. After the data is imported to the database, the system automatically updates and displays the changed indicators on the product side.

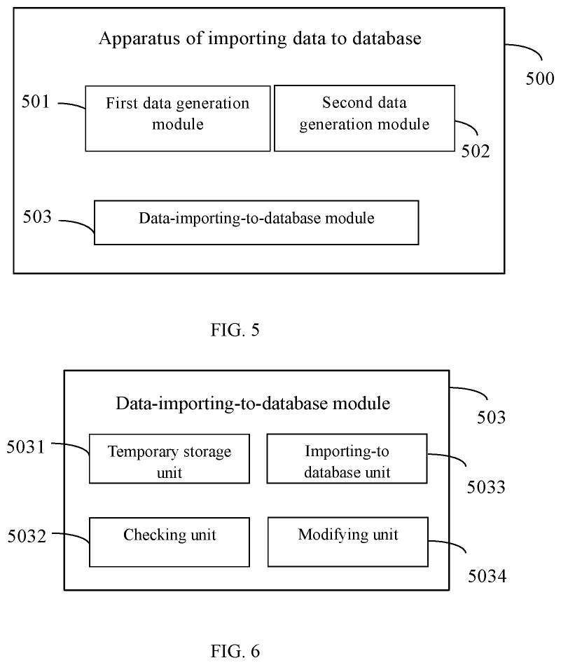

The present disclosure further provides an apparatus 500 of importing data to a database, as shown in FIG. 5, including modules 501 to 503.

A first data generation module 501 is used to acquire incoming data from a data source according to a database config file; wherein the incoming data is original data directly acquired from the data source.

For example, the original data may include user data (data collected under user authorization) acquired from the data source, such as traffic data provided by a map application, which may be generated based on a mobile terminal and may include but not limited to real-time location information, driving speed information of users. The original data may also include public transportation data, such as data in a public transportation card terminal system, the number of people taking public transportation, boarding and alighting vehicle data, and the number of people entering and exiting stations, as well as the boarding situation of key routes, key stations, and key periods may be analyzed at any time by analyzing traffic card data and GPS data of public transportation vehicles. The original data may also include data in a video surveillance system, including road monitoring devices installed by the traffic management department, as well as monitoring networks installed by emergency, education, and urban managements, especially high-definition video cameras, which may accurately record detailed vehicle information such as vehicle types, license plates, and speeds, and pedestrian passing information may be acquired quickly and accurately by using multifunctional electric alarm devices and pedestrian crossing red light capture devices installed at some intersections combined with facial recognition technology. The original data may also include and urban vehicle GPS data, such as the location information data of transportation vehicles such as taxis and ride hailing services, which may also expand road condition data. Various road sections and various types of vehicles may also be monitored in real time by connecting with the network of the management department, so as to provide supplementary data.

The database config file is pre-configured manually, including a plurality of target parameters, such as the road type, the indicator name, the data type, etc. as shown in Table 1. The target parameters are not limited to the parameters listed in Table 1. Other parameters may be added according to real application scenarios. The database config file is used to guide the system to preprocess the original data before importing the data to the database, and determine which indicator data needs to be generated and how to generate the indicator data according to one or more target parameters. As shown in Table 1, each row in the config file represents one indicator. The config file also provides certain specifications on how to pump data for each indicator, such as determining the name, access address, and time granularity (fifteen-minute level or hour level) of the indicator.

For example, as shown in FIG. 3, the incoming data refers to the data that needs to be acquired through accessing the data source interface. In the embodiment, the data source interface may be a traffic management API. The incoming data may be data directly acquired from the data source through the traffic management API, such as real-time location information of users, driving speed on a certain road, etc.

A second data generation module 502 is used to calculate and process the incoming data according to the database config file to obtain computational data; wherein the computational data is obtained by integrating and calculating the incoming data, and cannot be directly acquired from the data source.

As shown in Table 1 and FIG. 3, in order to adapt to a wider range of data acquisition needs, data is divided into the incoming data and the computational data in the present disclosure. The computational data requires further integration and calculation of the already acquired incoming data. For example, road traffic congestion (computational data) is calculated according to real-time location information of users and driving speed information (incoming data). The traffic management department may obtain a large amount of real-time basic user data through docking, and the system integrates and calculates the massive incoming data to obtain the computational data.

A data-importing-to-database module 503 is used to write the incoming data and the computational data into a database.

The incoming data and the computational data are imported to the database, so that the data types in the database become more diverse. When users need, the incoming data and/or the computational data may be directly acquired from the database and quickly feed-backed to the user through the APP. The accuracy, real-time performance, and reliability of the data are high, and the cost and difficulty of acquiring the data are low. The generated computational data may also be directly applied to generate the intelligent analysis report required by the user. In this way, the user does not need to further integrate and calculate the computational data after acquiring the required computational data, significantly improving the efficiency of data acquisition and the user experience.

As an optional implementation, as shown in FIG. 6, the data-importing-to-database module 503 includes:
a temporary storage unit 5031 used to write the incoming data and the computational data into a staging file;
a checking unit 5032 used to check whether a data format of the incoming data and a data format of the computational data in the staging file is consistent with a preset data format in the database config file;
an importing-to-database unit 5033 used to write, in response to the data format of the incoming data and the data format of the computational data being consistent with the preset data format, the incoming data and the computational data from the staging file into the database; and
a modifying unit 5034 used to modify, in response to the data format of the incoming data and the data format of the computational data being inconsistent with the preset data format, the data format of the incoming data and the data format of the computational data to be consistent with the preset data format, and the importing-to-database unit writes the modified incoming data and the modified computational data from the staging file into the database.

As shown in FIG. 3, the system of importing data to the database in the embodiment introduces a staging area as an intermediate layer between data acquisition and data importing to the database. The staging area may store data in a form of CSV locally. The data may be imported to the database through query writing on these CSV files. In addition to the form of CSV, the data may also be in other forms. The introduction of the staging area is mainly to reduce the number of interactions between the data system and the database, as too many direct read and write operations on the database are unsafe. When it is uncertain whether the data in the data source is complete, writing the data directly to the database may affect the security of the database. For example, the existing data task requires 10 write operations on the data. However, when an error occurs or a data quality issue is discovered during the 5th write to the database, it is needed to not only locate the problem of the data source, but also delete the erroneous data that has already been imported to the database, which is an unsafe operation for the database. Therefore, in the embodiment, the data accessed each time is first written to the staging file in the form of CSV. When the data task is completed, all data in the staging file is updated to the database after confirming that all data are correct. In this way, for a data read task, the system may only have one update and write operation on the database, improving the security of read and write operations on the database.

For example, the format check program may automatically check the data format before importing the data in the staging file to the database, so as to confirm if there are any errors in the data format. Whether the data format of all data in the staging file is consistent with the preset data format in the database config file is checked. Whether each column of the incoming and the computational data in the CSV format is consistent with the database config file is checked. For example, according to the database config file in Table 1, if the first column of data is “road type”, whether the first column of data in the staging file is also “road type” is checked, and whether there are any empty values in each column is checked. It is determined whether the data format of all data in the staging file meets the requirements of the database config file, that is, whether the data format of all data in the staging file is consistent with the preset data format. If it is determined that the data is correct, the data in the staging area is written to the database as a whole. If some data formats in the staging file are found to be incorrect, the data formats are modified until all data formats meet the requirements of the database config file before being imported to the database, so as to ensure the security of the database.

As an optional implementation, the data-importing-to-database module 503 writes the incoming data and the computational data from the staging file into the database, including: processing the incoming data and the computational data into a plurality of data slices; and writing the plurality of data slices in batches from the staging file into the database.

The existing data system sends a large number of data requests to the data source when acquiring data, which requires a lot of time. The data system in the embodiment provides a multi-threaded mode when accessing the interface, greatly reducing the access time. During the stage of importing data in the staging area to the database, data slicing is also used to accelerate the data importing process. When the CSV data has thousands of rows, writing through an insertion statement, or writing with an insertion statement for each row, may be very time-consuming. Therefore, when importing the data to the database, the data in the large CSV file may be imported to the database in batches, with 500 pieces of data imported to the database in each batch. Such method of importing data to the database in batches may save a lot of time for importing data to the database.

As an optional implementation, the first data generation module 501 acquires the incoming data from the data source according to the database config file, including the following operations.

A data runtime period is acquired. The data runtime period includes a user input date or a preset date. The user input date refers to a date input by the user in real-time, indicating which time period of data the user wants to acquire, such as data of Mar. 1, 2023. The preset date may be pre-set in the data system, for example, data of the previous day may be run at 1 a.m. every day.

According to the database config file, the original data corresponding to the data runtime period is acquired from the data source as the incoming data.

For example, the data runtime period may be a date actively input by the user or a preset date, that is, running data tasks at a predetermined time may be supported. In order to make data tasks more convenient to run during product deployment, two new functions are added for the data system, including one-click initialization startup and timed tasks. When users run the data system of the present disclosure, they may also not input the date, and the system may automatically run the daily data of recent 14 days, weekly data of recent two weeks, and monthly data of recent two months to assist in generating daily, weekly, and monthly reports for traffic management scenarios. The data system may also be preset to perform a timed run on the data of the previous day, week, or month at 1:00 am every day, on every Monday, or on the 1st of every month. In this way, users do not need to manually input any dates, and the data system may automatically acquire the data for all dates required by the user, improving the convenience for the user to acquire data.

As an optional implementation, the first data generation module 501 includes:
a first determination unit used to acquire a first target parameter corresponding to the incoming data from the database config file;
a first acquisition unit used to acquire an identity document corresponding to each road in the incoming data from a road network file; wherein the incoming data is traffic data, and the road network file includes the identity document corresponding to each road in the traffic data and a hierarchical relationship between roads; and
a first generation unit used to acquire, according to the identity document and the first target parameter, the corresponding original data from the data source as the incoming data.

As shown in Table 1, when the types of data sources and the required indicator data increase, the request parameters for many data may also differ, and certain data is needed to provide data with specific granularity, such as certain indicators only having monthly data. In order to better cope with these complex scenarios, indicators such as the data type, the indicator acquisition granularity, and the request parameter are added. The data type determines whether the indicator is the incoming data or the computational data. The indicator acquisition granularity may help avoid invalid access. If an interface only has monthly data, the interface may not be accessed when running a daily data task. The request parameter specifies a necessary header to access an interface, and each header corresponds to a respective return data format.

The request parameters and addresses in Table 1 are divided into scope requests and aggregation requests. Here, the scope request parameter and the scope request address help to acquire daily data, such as the congestion index of an intersection every 15 minutes within 24 hours. The aggregation request parameter and the aggregation request address help to acquire aggregation data (weekly, monthly) in a plurality of days, such as the congestion index of a specific intersection every 15 minutes within 24 hours of a certain month in a year. The data of one indicator may be for a day or a month, but the interface address and the request parameter for the days are different from those for the months, so two separate fields are used to distinguish them. When the system runs a data task for a specific date or month, the corresponding scope or aggregation interface may be selected according to the database config file for data acquisition.

The road network file is a map of a city that provides road network information of the city, such as the intersections in the city and the ID of each intersection. The ID used here is consistent with the ID used when accessing the data interface, so when it is desired to acquire the indicator data of all intersections, the system may load all IDs in the road network file first. In the embodiment, the road network file not only provides all IDs for different road types, but also provides hierarchical relationships for different road types. For example, a region may have sub-regions, and each sub-region may have different roads, with different road sections and intersections for each road. Based on the IDs and hierarchical relationships provided by the road network file, richer indicator data may be obtained when generating the computational data.

As an optional implementation, data formats of the existing data system are only one-dimensional or two-dimensional, while the data system in the embodiment adapts to the newly added three-dimensional data. One-dimensional data refers to a single numerical value or text, typically appearing in the form of an integer, float, or text in the database. Multi-dimensional data is generally in a jsonb format in the database. Different types of jsonb data have different partitioning rules, such as KV, SIV, and the like. All jsonb data may be stored in a form of double list in the database. Dimensions of the jsonb data correspond to the length of each inner list. The length of a name of each jsonb data corresponds to its dimension, where each character in the name represents a different meaning. 2D jsonb data is generally in the form of KV, with each internal array containing a key value pair. The format of the 2D jsonb data is, for example, [[“7:30-9:00”, 1.354], [“17:20-19:05”, 1.345] . . . ].

Due to the increasing complexity of data in traffic management scenarios, two-dimensional data storage formats may no longer meet the needs of user in data acquisition. For example, when the data source provides frequent congestion periods for a certain month and data for different indicators during these periods, the user may need data in a third dimension. The newly added 3D jsonb format may be extended on the basis of 2D, as shown in Table 2. In the embodiment, three new characters are added, including space (S), time (T), and index (I). For example, the TIV format indicates that in each array, the first value represents the time period, the second value represents the index, and the third value represents the corresponding value.

Table 3 presents the jsonb format data in the TIV format in a table form. By expanding the dimensions of the data, one-dimensional and two-dimensional data are extended to three-dimensional data, adapting to complex data. For different times, indexes, and spaces, further selection may be made in the database config file. For example, when acquiring jsonb data in the TIV format, the data source may return 5 indexes, but the user may only choose 3 indexes. In this situation, it is only needed to add the three indexes selected by the user in the field “selected index” (default to selecting all) of the config file.

As an optional implementation, in order to solve the technical problem that each indicator corresponds to one data interface in the config file of the existing data system, which is a one-to-one mapping relationship and cannot adapt to complex data, the data system in the embodiment extends to one-to-many mapping relationship and many-to-one mapping relationship of indicators and interfaces, adapting to more complex data.

For example, firstly, a plurality of data sources may provide data for an index in the database config file. As mentioned above, the scope data request and the aggregation data request are typical examples of the many-to-one mapping relationship, and such an index may have data such as daily data, weekly data, or monthly data. Another many-to-one mapping relationship is data with the same granularity provided by the plurality of data sources. For example, the data sources may have three types, including sub roads, parent roads, and trunk roads. However, the indicator in the present disclosure is specific to roads and includes these three road types. In order to enable the road indicator data to acquire data from these three data interfaces, three request addresses may all be written to the request address position of the database config file. In this way, the data system may traverse these data source interfaces to find suitable data for acquisition.

In addition, the data system also supports one data source to provide data for a plurality of different indicators. For example, a certain interface provides a congestion indicator for every 5 minutes in 24 hours of a certain day or of each day in a month, and such congestion indicator data includes indicator data such as a congestion index and a congestion mileage in the form of a dictionary. Assuming that indicator data of a five-minute level congestion index is to be established, the system may access this data source and use the field of selected index to select and list the indicator “congestion index”. Through the field of selected index, such data source may be used to establish indicators such as the congestion index and the congestion mileage, thereby achieving the many-to-one mapping relationship.

As an optional implementation, the second data generation module 503 includes:
a second determination unit used to acquire a second target parameter corresponding to the computational data from the database config file;
a second acquisition unit used to acquire an identity document and a hierarchical relationship corresponding to each road in the computational data from the road network file; and
a second generation unit used to calculate and process the incoming data according to the identity document, the hierarchical relationship, and the second target parameter, so as to obtain corresponding second indicator data as the computational data; wherein the calculating and processing includes at least one of: extracting the incoming data; or integrating the incoming data; ranking the incoming data.

For example, the establishment of computational data indicators is an important function of the data system in the present disclosure. The data system may not only access and adapt to the data interfaces provided by the traffic management, but also integrate, calculate, and rank the acquired incoming data. The system extracts, integrates, and ranks the acquired incoming data through fields of the config file, such as the indicator name, the data type, the data format, the selected index, the selected time period, and the selected area. For example, if it is desired to know which intersections are most congested during a specific time period or morning and evening rush hour in a certain area on a certain day, 3D jsonb data in the STV form in the database config file may be selected, the need for the intersections with top five congestion index rankings are declared in the selected area, and the need for all day, morning rush hour or evening rush hour are declared in the selected time period. In this way, the data system may interpret the parameters in the database config file, so as to ultimately calculate the data required by the user as shown in Table 4.

As an optional implementation, the apparatus of importing data to a database further includes:
a second data acquisition module used to read product side data regularly;
a determination module used to determine whether a difference exists between the product side data and the database config file;
the temporary storage unit 5031 writes, in response to the difference existing between the product side data and the database config file, difference data into the staging file;
wherein the second data acquisition module is returned, in response to the difference not existing between the product side data and the database config file, to read the product side data regularly;
wherein the checking unit 5032 checks whether a data format of the difference data is consistent with the preset data format after the temporary storage unit 5031 writes the difference data into the staging file;
wherein the importing-to-database unit 5033 writes, in response to the data format of the difference data being consistent with the preset data format, the difference data from the staging file into the database; and
wherein the modifying unit 5034 modifies, in response to the data format of the difference data being inconsistent with the preset data format, the data format of the difference data to be consistent with the preset data format, and the importing-to-database unit 5033 writes the modified difference data from the staging file into the database.

Specifically, when certain new types of data need to be imported to the database, it may be needed to modify or reconfigure the database config file to adapt to the new type of data being imported to the database. If the data configuration on the product side is not modified, it may lead to a difference between the data configuration on the product side and the database config file. Therefore, the product side data may be regularly read to update the product side data as well as the data to be imported in the staging file in a timely manner, so as to ensure the consistency between the product side data and the database.

As an optional implementation, the data system adds a display module to display update indicators of the product side data. The existing data system completes the task once the data is imported to the database. However, if the update indicators are needed to be displayed on the product side, the existing data system needs to add these update indicators one by one at the product level. When the number of new indicators is large, this step may consume a lot of time. Therefore, the data system in the embodiment achieves automatic display of updated indicators on a product side, as shown in FIG. 4. After the data is imported to the database, the system automatically updates and displays the changed indicators on the product side.

In the technical solution of the present disclosure, the collection, storage, use, processing, transmission, provision, disclosure, application and other processing of user personal information involved comply with provisions of relevant laws and regulations, take essential confidentiality measures, and do not violate public order and good custom. In the technical solution of the present disclosure, authorization or consent is obtained from the user before the user's personal information is obtained or collected.

According to an embodiment of the present disclosure, the present disclosure further provides an electronic device, a readable storage medium, and a computer program product.

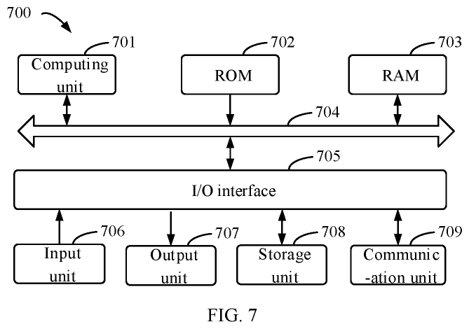

FIG. 7 shows a schematic block diagram of an example electronic device 700 used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the device 700 may include a computing unit 701, which may perform various appropriate actions and processing based on a computer program stored in a read-only memory (ROM) 702 or a computer program loaded from a storage unit 708 into a random access memory (RAM) 703. Various programs and data required for the operation of the device 700 may be stored in the RAM 703. The computing unit 701, the ROM 702 and the RAM 703 are connected to each other through a bus 704. An input/output (I/O) interface 705 is further connected to the bus 704.

Various components in the device 700, including an input unit 706 such as a keyboard, a mouse, etc., an output unit 707 such as various types of displays, speakers, etc., a storage unit 708 such as a magnetic disk, an optical disk, etc., and a communication unit 709 such as a network card, a modem, a wireless communication transceiver, etc., are connected to the I/O interface 705. The communication unit 709 allows the device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 701 may perform the various methods and processes described above, such as the method of importing data to a database. For example, in some embodiments, the method of importing data to a database may be implemented as a computer software program that is tangibly contained on a machine-readable medium, such as the storage unit 708. In some embodiments, part or all of a computer program may be loaded and/or installed on the device 700 via the ROM 702 and/or the communication unit 709. When the computer program is loaded into the RAM 703 and executed by the computing unit 701, one or more steps of the method of importing data to a database described above may be performed. Alternatively, in other embodiments, the computing unit 701 may be used to perform the method of importing data to a database in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a special-purpose or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, and infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

According to an embodiment of the present disclosure, an intelligent transportation data system is further provided, including the electronic device in the above embodiments.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of importing data to a database, comprising:
acquiring incoming data from a data source according to a database config file; wherein the incoming data is original data directly acquired from the data source;
calculating and processing the incoming data according to the database config file to obtain computational data; wherein the computational data is obtained by integrating and calculating the incoming data; and
writing the incoming data and the computational data into the database.

2. The method according to claim 1, wherein the writing the incoming data and the computational data into the database comprises:
writing the incoming data and the computational data into a staging file;
checking whether a data format of the incoming data and a data format of the computational data in the staging file is consistent with a preset data format in the database config file;
writing, in response to the data format of the incoming data and the data format of the computational data being consistent with the preset data format, the incoming data and the computational data from the staging file into the database; and
modifying, in response to the data format of the incoming data and the data format of the computational data being inconsistent with the preset data format, the data format of the incoming data and the data format of the computational data to be consistent with the preset data format, and writing the modified incoming data and the modified computational data from the staging file into the database.

3. The method according to claim 1, wherein the acquiring incoming data from a data source according to a database config file comprises:
acquiring a data runtime period, wherein the data runtime period comprises a user input date or a preset date; and
acquiring, according to the database config file, the original data corresponding to the data runtime period from the data source as the incoming data.

4. The method according to claim 1, wherein the acquiring incoming data from a data source according to a database config file further comprises:
acquiring a first target parameter corresponding to the incoming data from the database config file;
acquiring an identity document corresponding to each road in the incoming data from a road network file; wherein the incoming data is traffic data, and the road network file comprises the identity document corresponding to each road in the traffic data and a hierarchical relationship between roads; and
acquiring, according to the identity document and the first target parameter, corresponding original data from the data source as the incoming data.

5. The method according to claim 4, wherein the calculating and processing the incoming data according to the database config file to obtain computational data comprises:
acquiring a second target parameter corresponding to the computational data from the database config file;
acquiring an identity document and a hierarchical relationship corresponding to each road in the computational data from the road network file; and
calculating and processing the incoming data according to the identity document, the hierarchical relationship, and the second target parameter, so as to obtain corresponding second indicator data as the computational data;
wherein the calculating and processing comprises at least one of: extracting the incoming data; integrating the incoming data; or ranking the incoming data.

6. The method according to claim 2, wherein writing the incoming data and the computational data from the staging file into the database comprises:
processing the incoming data and the computational data into a plurality of data slices; and
writing the plurality of data slices in batches from the staging file into the database.

7. The method according to claim 2, further comprising:
reading product side data regularly;
determining whether a difference exists between the product side data and the database config file;
writing, in response to the difference existing between the product side data and the database config file, difference data into the staging file;
returning, in response to the difference not existing between the product side data and the database config file, to read the product side data regularly;
checking, after writing the difference data into the staging file, whether a data format of the difference data is consistent with the preset data format;
writing, in response to the data format of the difference data being consistent with the preset data format, the difference data from the staging file into the database; and
modifying, in response to the data format of the difference data being inconsistent with the preset data format, the data format of the difference data to be consistent with the preset data format, and writing the modified difference data from the staging file into the database.

8. The method according to claim 1, wherein the database config file comprises at least one of: a road type; an indicator name; a data type; an indicator acquisition granularity; a data request scope; an aggregation request parameter; a data format; a scope request address; an aggregation request address; a time granularity; a selected index; or a selected time period.

9. An electronic device, comprising:
at least one processor; and
a memory communicatively connected to the at least one processor, wherein the memory stores instructions executable by the at least one processor, and the instructions, when executed by the at least one processor, cause the at least one processor to:
acquire incoming data from a data source according to a database config file; wherein the incoming data is original data directly acquired from the data source;
calculate and process the incoming data according to the database config file to obtain computational data; wherein the computational data is obtained by integrating and calculating the incoming data; and
write the incoming data and the computational data into the database.

10. The electronic device according to claim 9, wherein the at least one processor is further configured to:
write the incoming data and the computational data into a staging file;
check whether a data format of the incoming data and a data format of the computational data in the staging file is consistent with a preset data format in the database config file;
write, in response to the data format of the incoming data and the data format of the computational data being consistent with the preset data format, the incoming data and the computational data from the staging file into the database; and
modify, in response to the data format of the incoming data and the data format of the computational data being inconsistent with the preset data format, the data format of the incoming data and the data format of the computational data to be consistent with the preset data format, and write the modified incoming data and the modified computational data from the staging file into the database.

11. The electronic device according to claim 9, wherein the at least one processor is further configured to:
acquire a data runtime period, wherein the data runtime period comprises a user input date or a preset date; and
acquire, according to the database config file, the original data corresponding to the data runtime period from the data source as the incoming data.

12. The electronic device according to claim 9, wherein the at least one processor is further configured to:
acquire a first target parameter corresponding to the incoming data from the database config file;
acquire an identity document corresponding to each road in the incoming data from a road network file; wherein the incoming data is traffic data, and the road network file comprises the identity document corresponding to each road in the traffic data and a hierarchical relationship between roads; and
acquire, according to the identity document and the first target parameter, corresponding original data from the data source as the incoming data.

13. The electronic device according to claim 12, wherein the at least one processor is further configured to:
acquire a second target parameter corresponding to the computational data from the database config file;
acquire an identity document and a hierarchical relationship corresponding to each road in the computational data from the road network file; and
calculate and process the incoming data according to the identity document, the hierarchical relationship, and the second target parameter, so as to obtain corresponding second indicator data as the computational data;
wherein the calculating and processing comprises at least one of: extracting the incoming data; integrating the incoming data; or ranking the incoming data.

14. The electronic device according to claim 10, wherein the at least one processor is further configured to:
process the incoming data and the computational data into a plurality of data slices; and
write the plurality of data slices in batches from the staging file into the database.

15. The electronic device according to claim 10, wherein the at least one processor is further configured to:
read product side data regularly;
determine whether a difference exists between the product side data and the database config file;
write, in response to the difference existing between the product side data and the database config file, difference data into the staging file;
return, in response to the difference not existing between the product side data and the database config file, to read the product side data regularly;
check, after writing the difference data into the staging file, whether a data format of the difference data is consistent with the preset data format;
write, in response to the data format of the difference data being consistent with the preset data format, the difference data from the staging file into the database; and
modify, in response to the data format of the difference data being inconsistent with the preset data format, the data format of the difference data to be consistent with the preset data format, and write the modified difference data from the staging file into the database.

16. The electronic device according to claim 9, wherein the database config file comprises at least one of: a road type; an indicator name; a data type; an indicator acquisition granularity; a data request scope; an aggregation request parameter; a data format; a scope request address; an aggregation request address; a time granularity; a selected index; or a selected time period.

17. A non-transitory computer-readable storage medium having computer instructions stored thereon, wherein the computer instructions are configured to cause a computer to:
acquire incoming data from a data source according to a database config file; wherein the incoming data is original data directly acquired from the data source;
calculate and process the incoming data according to the database config file to obtain computational data; wherein the computational data is obtained by integrating and calculating the incoming data; and
write the incoming data and the computational data into the database.

18. The non-transitory computer-readable storage medium according to claim 17, wherein the computer instructions are further configured to cause the computer to:
write the incoming data and the computational data into a staging file;
check whether a data format of the incoming data and a data format of the computational data in the staging file is consistent with a preset data format in the database config file;
write, in response to the data format of the incoming data and the data format of the computational data being consistent with the preset data format, the incoming data and the computational data from the staging file into the database; and
modify, in response to the data format of the incoming data and the data format of the computational data being inconsistent with the preset data format, the data format of the incoming data and the data format of the computational data to be consistent with the preset data format, and write the modified incoming data and the modified computational data from the staging file into the database.

19. The non-transitory computer-readable storage medium according to claim 17, wherein the computer instructions are further configured to cause the computer to:
acquire a data runtime period, wherein the data runtime period comprises a user input date or a preset date; and
acquire, according to the database config file, the original data corresponding to the data runtime period from the data source as the incoming data.

20. An intelligent transportation data system, comprising the electronic device of claim 9.
